(19) United States
(12) Patent Application Publication
(10) Pub. No.: US 2021/0153644 A1
(43) Pub. Date: May 27, 2021

(54) LAP FREE PORTABLE SMART STANDING DESK

(71) Applicant: Max Daniel Pierre, Brooklyn, NY (US)

(72) Inventor: Max Daniel Pierre, Brooklyn, NY (US)

(21) Appl. No.: 17/159,992

(22) Filed: Jan. 27, 2021

Related U.S. Application Data
(60) Provisional application No. 62/941,430, filed on Nov. 27, 2019.

(51) Int. Cl. A47B 23/00; A45F 5/00; F16M 13/04

(52) U.S. Cl. CPC A47B 23/002; A45F 5/00; A45F 2200/0525; A45F 2200/0516; F16M 13/04

(57) ABSTRACT

According to some embodiments, a portable computer desk may be worn by a user to allows a user to stand and be mobile at the same time. The portable computer desk comprises a shoulder harness coupled to an adjustable extension rod. A waist harness is also coupled to the extension rod. A platform is coupled to the extension rod.

### BACKGROUND

A standing desk allows a user to work at a computer while standing up or while sitting on a high stool. There is a significantly higher mortality rate among people who regularly sit for prolonged periods so standing while working may help computer users live longer because it provides users with a standing option so that they may reduce how long they sit. However, like a conventional desk that is stationary, a standing desk does not provide mobility for users. Therefore, it would be desirable to create a standing desk that also provides mobility for a user.

### SUMMARY

Some embodiments described herein relate to a portable computer desk that may be worn by a user to allow a user to stand and be mobile at the same time. The portable computer desk comprises a shoulder harness coupled to an adjustable extension rod. A waist harness is also coupled to the extension rod. A platform is coupled to the extension rod.

### BRIEF DESCRIPTION OF THE DRAWING

FIG. 1 illustrates a portable computer desk in accordance with some embodiments.

FIG. 2 illustrates a portable computer desk in accordance with some embodiments.

FIG. 3 illustrates a user using a portable computer desk in accordance with some embodiments.

FIG. 4 illustrates a portable computer desk in accordance with some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, and components have not been described in detail so as not to obscure the embodiments. In the following detailed description, numerous specific details are set forth in order to provide a thorough understanding of the embodiments. However, it will be understood by those of ordinary skill in the art that the embodiments may be practiced without these specific details. In other instances, well-known methods, procedures, and components have not been described in detail so as not to obscure the embodiments. The present embodiments described herein relate to a lap free portable computer desk that may be worn by a user to allow a user to stand and be mobile at the same time. Furthermore, the present embodiments described herein relate to a stand that allows for screened devices, such as, but not limited to, tablet computers, laptops, mobile phones or other portable electronic devices comprising a screen, to be used in a mobile situation.

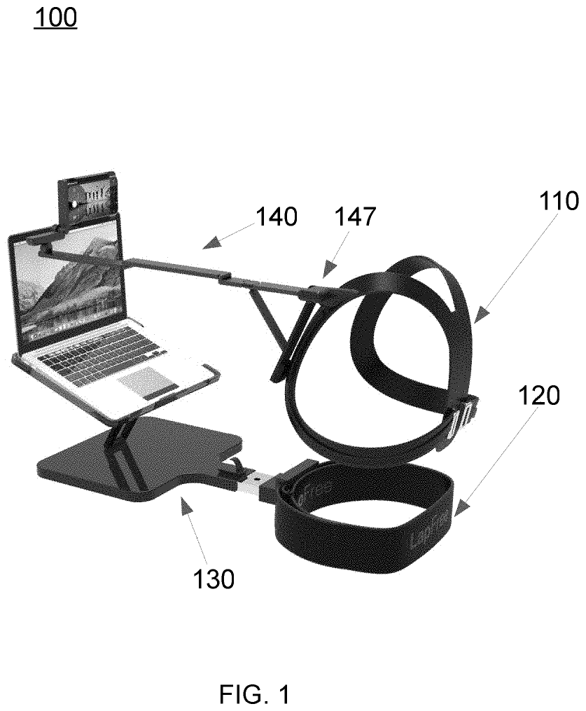

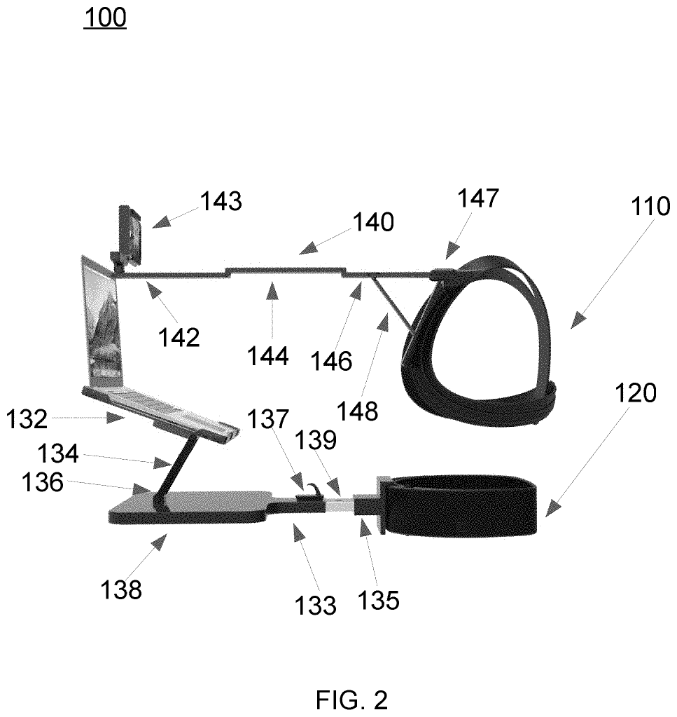

Referring to FIG. 1 and FIG. 2, a portable computer desk 100 is illustrated. Referring to FIG. 1, the portable computer desk 100 comprises a shoulder harness 110, a waist harness 120 and a platform 130. The shoulder harness 110 comprises a plurality of straps to extend over a user's shoulders and, in some embodiments, the straps may be adjusted at a centralized portion or, in some embodiments, each strap may comprise an individual adjustment. The straps may be comprised of, but not limited to, leather, vinyl or fabric. Adjusting the straps may be based on shortening or lengthening each of the straps to create a proper fit for the user. The waist harness 120 may be configured to circumscribe (e.g., go around) the waist of a user, The waist harness 120 may be adjusted at a front portion (i.e., located at a front side of a user/a location where a belt buckle is normally located). For example, the waist harness 120 may comprise a buckle that is used to adjust the waist harness 120 (e.g, tighter or loosen). The buckle may also be configured to couple an extension rod to the waist harness 120. The waist harness 120 may be comprised of, but not limited to, leather, vinyl or fabric.

In some embodiments, a phone holder arm 140 may be coupled to the shoulder harness 110. The phone holder arm 140 may be used to couple a cell phone, tablet, or other small object. The phone holder arm 140 may be comprised of an extension anchor 147 coupled to the shoulder harness and one or more extensions movably coupled to the extension anchor 147.

Now referring to FIG. 2, the portable computer desk 100 further comprises a lifting mechanism that includes a hinge 136 and one or more rods 134 coupled between the hinge 136 and a laptop holder 132. The lifting mechanism is configured to lift the laptop holder 132 vertically and to allow it to move closer or further away from a user. The lifting mechanism comprising the hinge 136 and the one or more rods 134 may be used to adjust a distance a laptop is from a user to accommodate individual vision and arm length associated with the user.

As stated above, the waist harness 120 may comprise a buckle 135 that may be used to adjust the waist harness 120 (e.g., tighter or loosen). The buckle 135 may also be used to couple an extension rod 133 to the waist harness 120. A flat portion 138 of the platform 130 may be configured move forward and backward over the extension rod 122 to adjust a distance of the flat portion 138 (and thus the laptop or other device) from a user. A position of the platform 130 may be secured at a desired location by inserting a pin of a locking mechanism 137 into one of a plurality of adjustment holes 139. The platform 130 and the locking mechanism 137 may move up or down on the extension rod 133 and a position may be secured by inserting the pin into an adjustment hole 139. The locking mechanism 137 may also comprise a curved portion to couple a connector or cord from the locking mechanism 137 to the shoulder harness 110.

The laptop holder 132 may be configured to secure a laptop by having raised sides to prevent a laptop or other computing device from slipping out. The sides may also be used to pressure fit the laptop or other computing device. In some embodiments, the laptop holder 132 may be exchangeable to fit specific laptops or computing devices. In some embodiments, the laptop holder may comprise adjustable sides. In some embodiments, the sides may only be in contact with the corners of the laptop to as to not impede typing. The one or more rods 134 may comprise a plurality of rods each coupled to the hinge and the laptop connector. Using multiple rods may allow for greater stability of the laptop holder 132. The hinge 136 may lock at a plurality of different positions to prevent the one or more rods 134 from moving out of position.

In some embodiments, the waist harness 120 may comprise one or more batteries or power banks that are connected via electrical connections to the laptop holder 132 or the flat portion 138 in order to power a laptop portable computer, tablet or wireless device. In some embodiments, the flat portion 138 or the laptop holder 132 may be able to rotate between 0 to 90 degrees (e.g., 45 degrees) in order to share a screen with a person standing next to the user.

As illustrated in FIG. 2, the phone holder arm 140 may be coupled to the shoulder harness 110 via the extension anchor 147. The phone holder arm 140 may be comprised of a plurality of sections (e.g., sections 142, 144, and 146) where each section is movably coupled to each adjacent section. The extension anchor 147 may supported by support beam 148 to reduce sag in the phone holder arm 140. At a distal end of the phone holder arm 140, a phone holder 143 may be coupled where the phone holder 143 is configured to secure a phone (e.g., a smart phone or tablet device). The phone holder 143 may be constructed similar to the construction of the laptop holder 132.

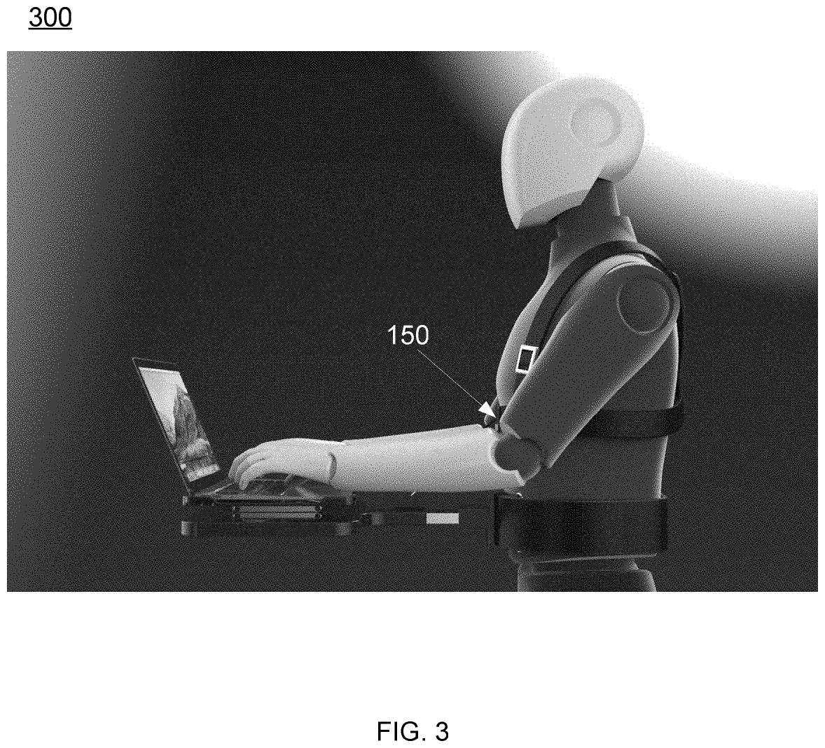

Referring now to FIG. 3, an example of a user wearing the portable computer desk 100 is illustrated. As shown in FIG. 3, a laptop can be in a lowered position unlike the laptop illustrated in FIG. 1 and FIG. 2 which is shown in a raised position. Also, and as shown in FIG. 3, the shoulder harness 110 may be coupled to locking mechanism 137 via a cable 150. Cable 150 may be comprised of cloth, a plastic or a metal. Cable 150 may help prevent the portable computer desk 100 from sagging or being pulled down. As illustrated in the embodiment of FIG. 3., the shoulder harness 110 may be adjusted through front buckles.

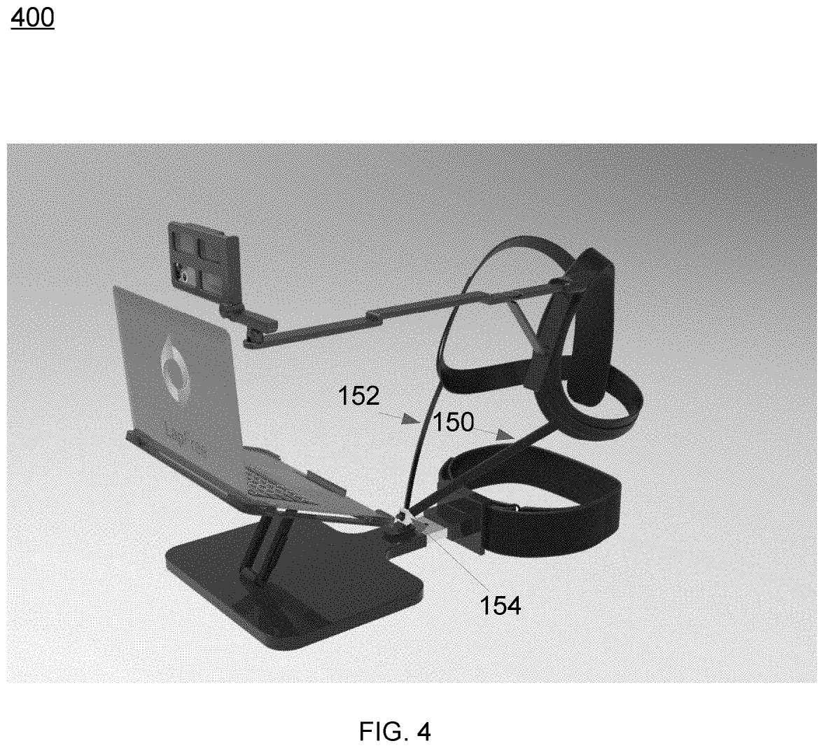

Referring now to FIG. 4, an example of a portable computer desk 100 is illustrated. As shown in FIG. 4, the shoulder harness 110 may be coupled to locking mechanism 137 via a cable 150. Cable 150 may be comprised of cloth, a plastic or a metal. In some embodiments, cable 150 may be solid and in some embodiments, cable 150 may be flexible. Cable 150 may help prevent the portable computer desk 100 from sagging or being pulled down. As further illustrated in FIG. 4, a second cable 152 may be used to further support the portable computer desk 100 by coupling a second cable from the shoulder harness 110 to the locking mechanism 137. Second cable 152 may be comprised of cloth, a plastic or a metal. In some embodiments, an end of the cable 150 may comprise an opening 154 to couple the locking mechanism 137.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A portable computer desk comprising;
a shoulder harness coupled to an adjustable extension rod;
a waist harness coupled to the extension rod; and
a platform coupled to the extension rod.

2. The portable computer desk of claim 1, further comprising:
a hinge coupled to the platform;
a height adjusting rod coupled to the hinge; and
a laptop holder coupled to the height adjusting rod.

3. The portable computer desk of claim 2, further comprising:
an extension anchor coupled to the shoulder harness;
a first of a plurality sections movably coupled to the extension anchor; and
a second of a plurality sections movably coupled to the first of the plurality of sections.

4. The portable computer desk of claim 1, wherein the adjustable extension rod comprises a hook to removably couple a cable between the shoulder harness and the adjustable extension rod.

5. A portable computer desk comprising;
a shoulder harness coupled to an adjustable extension rod;
a waist harness coupled to the extension rod;
a platform coupled to the extension rod;
a hinge coupled to the platform;
a height adjusting rod coupled to the hinge; and
a laptop holder coupled to the height adjusting rod.

6. The portable computer desk of claim 5, further comprising:
an extension anchor coupled to the shoulder harness; and
a plurality of cell phone extensions movably coupled to the extension anchor.

7. The portable computer desk of claim 6, wherein the adjustable extension rod comprises a hook to removably couple a cable between the shoulder harness and the adjustable extension rod.

8. A portable computer desk comprising;
a shoulder harness coupled to an adjustable extension rod;
a waist harness coupled to the extension rod;
a platform coupled to the extension rod;
a hinge coupled to the platform;
a height adjusting rod coupled to the hinge; and
a laptop holder coupled to the height adjusting rod.

9. The portable computer desk of claim 8, further comprising:
an extension anchor coupled to the shoulder harness; and
a plurality of cell phone extensions movably coupled to the extension anchor.

10. The portable computer desk of claim 8, wherein the adjustable extension rod comprises a hook to removably couple a cable between the shoulder harness and the adjustable extension rod.
